(19) United States
(12) Patent Application Publication
(10) Pub. No.: US 2024/0117873 A1
(43) Pub. Date: Apr. 11, 2024

(54) TRANSMISSION AND METHOD FOR OPERATING A TRANSMISSION

(71) Applicant: Flender GmbH, Bochold (DE)

(72) Inventors: Sarah Bröcker, Bocholt (DE); MARKUS DEGELING, Rhede (DE); CHRISTIAN KÖNIG, Bochum (DE)

(73) Assignee: Flender GmbH, Bochold (DE)

(21) Appl. No.: 18/273,226

(22) PCT Filed: Feb. 3, 2022
(86) PCT No.: PCT/EP2022/052520

§ 371 Date: Jul. 19, 2023

(30) Foreign Application Priority Data
Feb. 26, 2021 (DE) 10 2021 201 875.0

(51) Int. Cl. F16H 57/04

(52) U.S. Cl. CPC F16H 57/042; F16H 57/045; F16H 57/0479; F05B 2220/705; F05B 2260/98

(57) ABSTRACT

A transmission includes a first transmission stage, a feedthrough extending through the first transmission stage, and a first deflector designed to deflect a lubricant away from the feedthrough.

The invention relates to a transmission and to a method for operating a transmission. The transmission is coupled in particular to an electric machine. The electric machine is a motor or a generator. The transmission is located, for example, in a heavy machinery drive train for a wind turbine or a mill for, e.g. ores or cement.

Greater system integration of the wind turbine transmission with the generator means that the requirements regarding the tightness of the transmission increase. For example, the sealing of the pitch tube with respect to the generator is particularly critical since oil emerging here can damage the generator.

In the case of conventional transmission designs, there is an axial space between each sun and the closest rotor-side component. Trapped oil from the intermeshing of the running gears is pressed into said space and runs axially via the pitch tube, because of the inclination of the transmission, in the direction of the generator.

In the case of integrated concepts, the pitch tube can be mounted radially in the generator. This causes the shielding effect of the bearing on the pitch tube to cease, and the trapped oil from the running gears of the planetary stages is conducted directly in front of the seal to the generator.

In the case of non-integrated concepts, the axis of the pitch tube and generator is not coaxial. In this case, the pitch tube is mounted in the transmission housing. The bearing additionally takes on here the function of the oil shielding effect. The pitch tube is sealed to the outside e.g. by a simple labyrinth seal.

EP 2 541 058 B1 discloses a drive system which has a transmission unit comprising at least one planetary gear stage. The planetary gear stage here has an internal gear, a plurality of planetary gears, a planet carrier and a sun gear. A pitch tube which extends axially over the entire drive system is arranged within an output shaft and a rotor hollow shaft.

DE 10 2019 207 102 A1 discloses a sealing concept for a rotary feedthrough of a vertically oriented transmission, in which outside a bearing for a pitch tube a collecting trough is provided for lubricant oil dripping from the bearing in the axial direction of gravity.

It is an object of the invention to specify a protective system for deflecting trapped oil from the pitch tube.

The object is achieved by a transmission having the features of claim 1 and by a method having the features of claim 11. Preferred embodiments are indicated in the dependent claims and the description below which each individually or in combination can constitute an aspect of the invention. If one feature is depicted in combination with another feature, this serves only for simplified illustration of the invention and is not intended in any way to mean that this feature cannot also be a development of the invention without the other feature.

An embodiment of the invention relates to a transmission, in particular for a wind turbine, having at least one first transmission stage, wherein the transmission has a feedthrough, wherein a first deflector is provided for deflecting a lubricant away from the feedthrough.

The transmission is in particular oriented substantially horizontally. The transmission is provided preferably for a wind turbine. In the designated installation position, the substantially horizontally oriented transmission is oriented at a slight angle with respect to the horizontal, that is to say by approx. 2° to 15°, in particular 3° to 10°, particularly preferably 4° to 5°. The at least one deflector can be designed to prevent lubricant, in particular trapped oil, from reaching the feedthrough. For this purpose, the deflector can be arranged at least with a part of the deflector in a path produced between an outlet point of the lubricant and the feedthrough. Without the deflector, lubricant could drip from the outlet point of the lubricant in the direction of gravity onto the feedthrough because of a slight oblique position of the transmission with respect to the horizontal. Since the deflector can be provided in the direction of gravity between the outlet point of the lubricant and the feedthrough, the dripping lubricant, driven by the effect of gravity, can be caught and removed by the deflector. This makes use of the finding that, when the transmission is in a slight oblique position, as is the case in particular when it is used in a wind turbine, in contrast to a purely horizontal orientation of the transmission the surface tension of the lubricant may not be sufficient that the lubricant remains adhering to the components of the outlet point because of adhesion forces caused by the surface tension, and can be removed there, and instead can be detached driven by gravity and can drip. In contrast to a purely vertically oriented transmission, the lubricant also does not drip past the feedthrough, but rather would strike against the feedthrough because of the direction of gravity, which is angled with respect to the orientation of the feedthrough, without a deflector which prevents this.

In particular, a second deflector is provided for deflecting the lubricant away from the feedthrough. The first deflector and the second deflector are preferably provided at different axial ends of the transmission and/or at different axial ends of the at least one transmission stage of the transmission. Particularly preferably, the first deflector is provided at a first end of the feedthrough and the second deflector at a second end of the feedthrough facing away in the axial direction from the first end. This makes it possible to avoid lubricant from being able to penetrate the openings of the feedthrough that are provided in the axial ends.

Preferably, the first deflector and/or the second deflector is/are arranged on one end side of the transmission and/or on one end side of a transmission stage of the transmission.

In an embodiment of the transmission, the transmission has at least one second transmission stage, wherein the first deflector and/or the second deflector is/are provided for deflecting lubricant between the first transmission stage and the second transmission stage.

In an embodiment of the transmission, the first deflector and/or the second deflector is/are connected fixedly to a sun gear.

In an embodiment of the transmission, the first deflector and/or the second deflector has/have a circular arc shape.

In an embodiment of the transmission, the first deflector and/or the second deflector has/have a channel.

In an embodiment of the transmission, the first deflector and/or the second deflector has/have compensation for an inclination of the transmission.

In an embodiment of the transmission, the first deflector and/or the second deflector projects/project into the circular recess, wherein the at least one deflector and the circular recess are arranged rotatably with respect to each other.

In an embodiment of the transmission, the first transmission stage has a planetary transmission, wherein the transmission in particular has an oil sump, wherein the feedthrough in particular is a pitch tube.

In an embodiment of the transmission, the first deflector and/or the second deflector has/have an electrically insulating material.

The invention furthermore relates to the use of a transmission, which can be designed and developed as described above, in an installation position angled with respect to a main axis of rotation of the transmission by 2° to 15°, in particular in a wind turbine. A main axis of rotation is understood as meaning an axis of rotation of the transmission corresponding to the axial direction, in particular an axis of rotation of a sun gear shaft connected to a sun gear.

The invention furthermore relates to a wind turbine having a transmission which is mounted angled with respect to the horizontal by 2° to 15° and which can be designed and developed as described above. The wind turbine can be designed and developed as explained above with reference to the transmission.

The invention furthermore relates to a method for operating a transmission which can be designed and developed as described above, wherein the first deflector and/or the second deflector deflect/deflects lubricants away from the feedthrough. The method can be designed and developed as explained above with reference to the transmission.

In an embodiment of the method, the lubricant is trapped oil.

In an embodiment of the method, lubricant deflected by the deflector is conducted into an oil sump.

In an embodiment of the transmission, mounting of the pitch tube in the transmission is possible. The pitch tube is a feedthrough. Furthermore, no further tightness requirements arise.

In an embodiment of the method, the transmission is connected to an electric machine, wherein the feedthrough is kept free from the lubricant.

The present invention will be explained in more detail below by way of example with reference to drawings, in which:

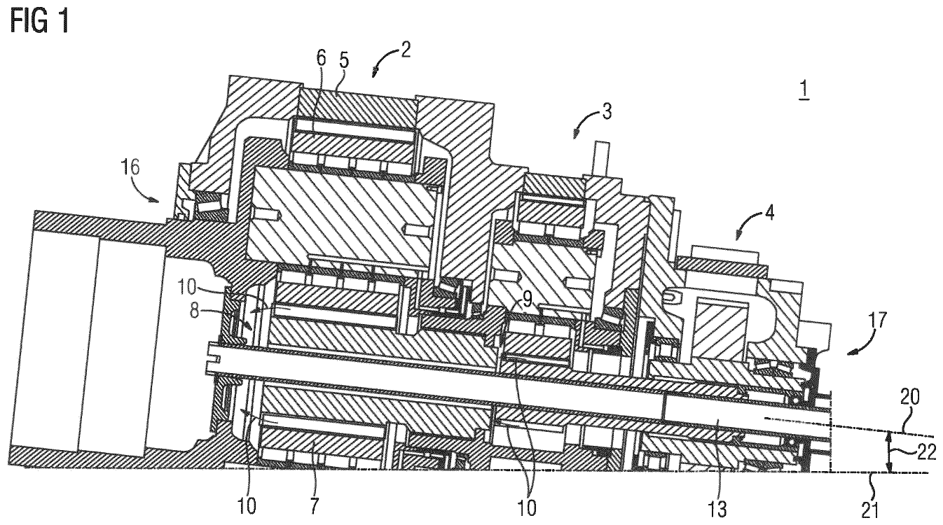

FIG. 1 shows a transmission in a sectional illustration,

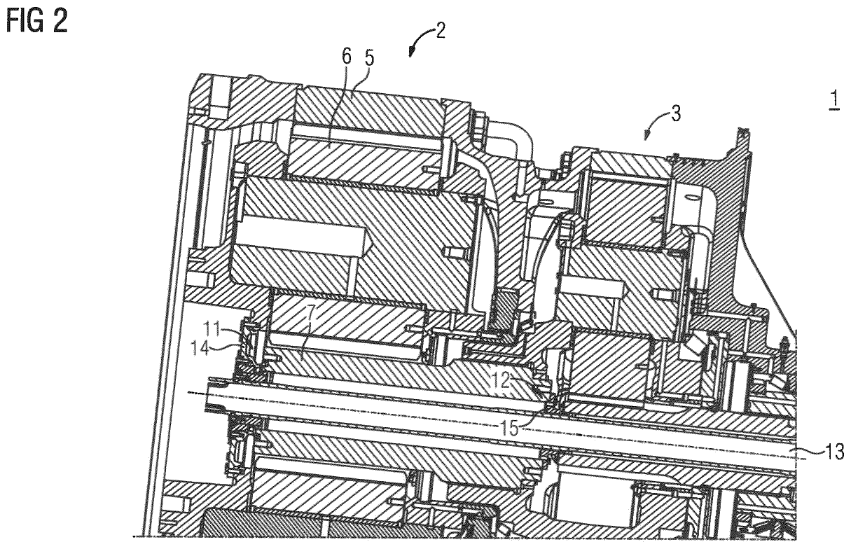

FIG. 2 shows a further transmission in a sectional illustration,

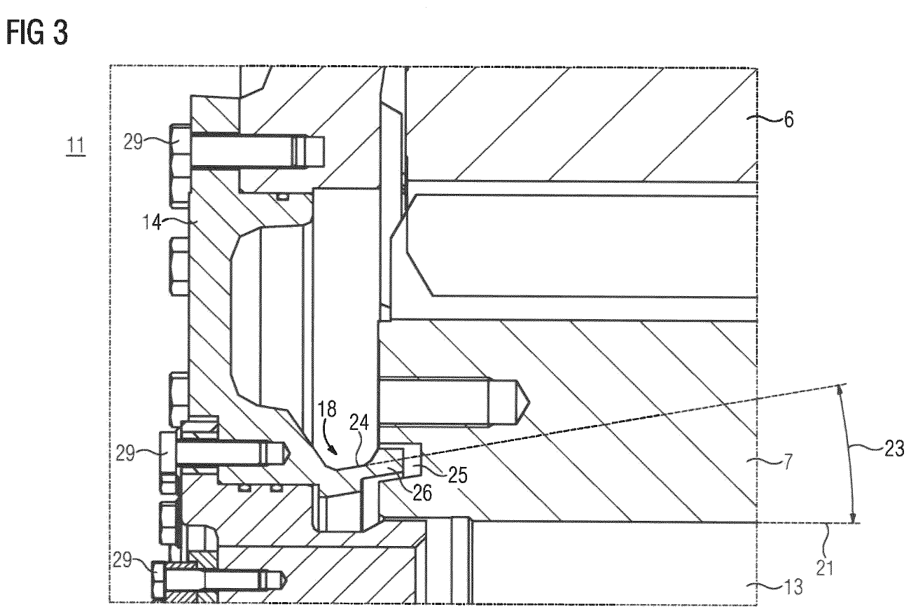

FIG. 3 shows a detail of the further transmission,

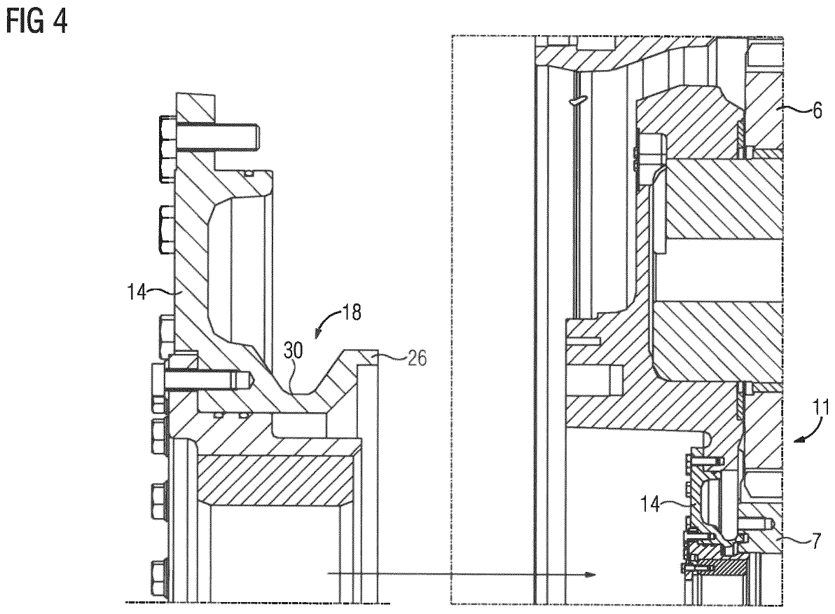

FIG. 4 shows a further detail of the further transmission, and

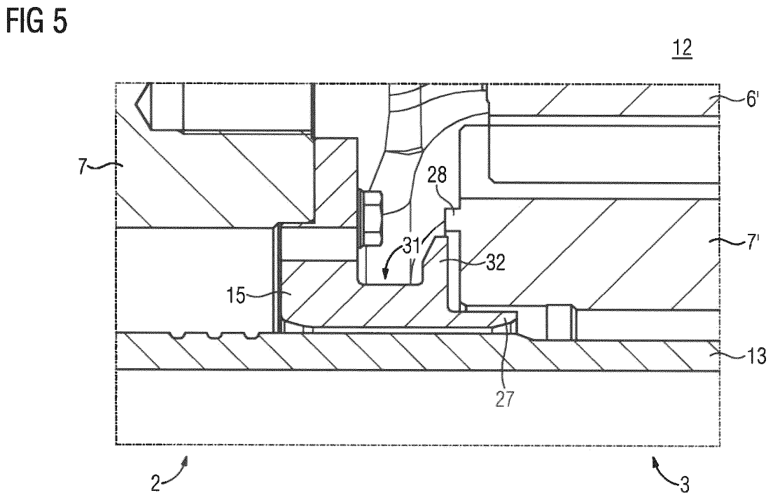

FIG. 5 shows a third detail of the further transmission.

The illustration according to FIG. 1 shows a transmission 1 with transmission stages 2, 3 and 4. The transmission 1 has end sides 16 and 17. A feedthrough 13, also called pitch tube, leads through the transmission 1. The axis 20 of the pitch tube has an inclination 22 with respect to a horizontal 21. The transmission stages 2 have an internal gear 5, planetary gears 6 and sun gears 7. There are cavities, an axial space LSS 8 and an axial space IMS 9. Trapped oil enters said spaces, this being indicated by arrows 10.

The illustration according to FIG. 2 shows a further transmission with transmission stages 2 and 3, wherein a first shielding system 11 and a second shielding system 12 are provided here. The shielding systems have deflectors 14 and 15. The deflectors deflect trapped oil. It is therefore possible for the pitch tube to remain free from trapped oil. An integrated protective system for deflecting trapped oil from the pitch tube is produced. In the case of this system, there is in particular a radially encircling deflection of oil between each sun and the closest rotor-side component. This shielding reduces the free space in front of the running gear. Most of the oil is therefore conducted directly into the oil sump. Shielding is configured in such a manner that there is an axial overlap with the sun, or the closest axially positioned component. By this means, the oil cannot pass directly onto the pitch tube. The shielding can be screwed to the sun, to the next closest component, or can be a geometrical part of the component or of the sun. A multiple shielding over different diameters is possible.

The illustration according to figure three shows a detail of the further transmission. The deflector 14 is fastened by screws 29. The deflector 14 has a channel 18 with an oblique channel base 24. Therefore, for example, an oblique installation of the transmission can be compensated for. The channel base 24 has an inclination 23 with respect to the horizontal 21.

The illustration according to FIG. 4 has a further detailed illustration of the deflector 14. An approximately horizontal channel base is shown here by way of example.

The Illustration according to FIG. 5 shows a further detail of the further transmission. It illustrates a second shielding system which is located in a region between the sun gear 7 and the sun gear 7′. Oil can also accumulate here in a channel 31. The channel is located in a deflector 15. The deflector 15 has a rim 27 which projects between the sun gear 7′ and the pitch tube 13. The deflector 15 also has a rim 32 which is at least partially located under an overhang 28 of the sun gear 7′. Trapped oil can thus slide from the sun gear 7′ via the overhang 28 and the rim 28 into the channel 31.

1.-15. (canceled)

16. A transmission, comprising:
a first transmission stage including a planetary transmission;
a feedthrough extending through the first transmission stage and designed as a pitch tube;
an oil sump; and
a first deflector designed to deflect a lubricant away from the feedthrough into the oil sump.

17. The transmission of claim 16 for installation in a wind turbine.

18. The transmission of claim 16, further comprising a second deflector designed to deflect the lubricant away from the feedthrough.

19. The transmission of claim 18, wherein at least one of the first deflector and the second deflector is arranged on one end side of the transmission.

20. The transmission of claim 18, further comprising a second transmission stage, wherein at least one of the first deflector and the second deflector is designed to deflect the lubricant between the first transmission stage and the second transmission stage.

21. The transmission of claim 18, wherein the first transmission stage comprises a sun gear, said at least one of the first deflector and the second deflector being connected fixedly to the sun gear.

22. The transmission of claim 18, wherein at least one of the first deflector and the second deflector has a circular arc shape.

23. The transmission of claim 18, wherein at least one of the first deflector and the second deflector has a channel.

24. The transmission of claim 18, wherein at least one of the first deflector and the second deflector has a compensation for an inclination of the transmission.

25. The transmission of claim 18, wherein at least one of the first deflector and the second deflector projects into a circular-arc-shaped recess, with the at least one of the first deflector and the second deflector and the circular recess being arranged rotatably with respect to each other.

26.-28. (canceled)

29. The transmission of claim 18, wherein at least one of the first deflector and the second deflector has an electrically insulating material.

30. The transmission of claim 16 designed for installation in an installation position that is angled with respect to a main axis of rotation of the transmission by 2° to 15°.

31. A method for operating a transmission which comprises a first transmission stage, a feedthrough extending through the first transmission stage, and a first deflector, said method comprising deflecting lubricant away from the feedthrough by the first deflector.

32. The method of claim 31, further comprising conducting the lubricant deflected by the first deflector into an oil sump.

33. The method of claim 31, further comprising connecting the transmission to an electric machine such that the feedthrough is kept free from the lubricant.

34. The method of claim 31, further comprising deflecting the lubricant away from the feedthrough by a second deflector of the transmission.

35. The method of claim 34, further comprising deflecting the lubricant by at least one of the first deflector and the second deflector between the first transmission stage and a second transmission stage of the transmission.
